(19) United States
(12) Patent Application Publication
(10) Pub. No.: US 2005/0268311 A1
(43) Pub. Date: Dec. 1, 2005

(54) Disk recording/reproducing device with tray

(76) Inventors: Kazuhiro Watanabe, Fukui (JP); Kenji Sakano, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/136,428

(22) Filed: May 25, 2005

(30) Foreign Application Priority Data
May 28, 2004 (JP) 2004-158969

(51) Int. Cl. G11B 17/03; G11B 17/04; G11B 33/02

(52) U.S. Cl. 720/601

(57) ABSTRACT

In order that a tray in a disk exchanging position may not be brought out or damaged even when it is pulled, a disk recording/reproducing device includes a rack loader made slidable perpendicularly to the carrying direction of the tray, and a switch for turning ON/OFF in response to sliding action of the rack loader. The rack loader has a cam rod boss rising therefrom, and the tray is provided on its bottom face with a rack extending in its carrying direction and meshing with a pinion, and a generally L-shaped cam groove for fitting the cam rod boss loosely therein. The cam groove has a longitudinal cam groove extending in parallel with the rack, a transverse cam groove perpendicular to the rack, a corner cam groove formed obliquely between the longitudinal cam groove and the transverse cam groove, a trapezoidal curve portion formed near the back end of the longitudinal cam groove and curved generally in a trapezoidal shape, and a straight portion formed behind the trapezoidal curve portion and lying on an extension line of the longitudinal cam groove. A central portion of the trapezoidal curve portion and the corner cam groove portion at passing time of the cam rod boss provide OFF area of the switch, and the longitudinal cam groove and the straight portion provide ON area of the switch.

### BACKGROUND OF THE INVENTION

1. Field of the Invention

The present invention relates to a disk recording/reproducing device provided with a tray for carrying a disk.

2. Related Art

In case a disk such as a DVD is to be recorded with data, or in case the recorded data are to be reproduced, a disk recording/reproducing device is employed such that the disk is placed on a turntable and is rotated at a high speed. A tracking control is made so that an information-reading beam may follow the information track on the disk, and a focusing control is made so that a beam spot may be precisely formed on the information track. Thus, the information is recorded and reproduced without fail.

When the disk is to be placed on the turntable, there is often employed a tray of the type, in which an opening swing door disposed in the front panel of a cabinet is slid to be opened and dosed. The disk is placed on the tray slid to protrude from the swing door and moved backward to be placed on the turntable.

A drive pinion to be rotated by a motor meshes with a rack of the tray so that the tray may be able to slide along a guide rail disposed in the disk device. When the disk is to be set or removed, the tray is pushed out into an open state, and the disk set on the tray is accommodated in the disk device as the tray moves backward. When the disk is to be reproduced, a traverse unit rises to push up the disk placed on the tray, and a spindle motor rotates at a high speed while clamping the disk on the turntable.

FIGS. 5A and 5B show a conventional general disk device. FIG. 5A shows the disk device in an open state, in which a tray 1 is pulled out, and FIG. 5B shows the disk device in a state in which the tray 1 is retracted and accommodated in the device body. When the disk is to be set, the tray 1 protrudes until the open state is established. That is, in order that the disk may be set in a predetermined position, the tray is provided at its center with a step 2 to form a circular recess and a hole 3. The tray protrudes at least until the circular recess may be exposed to the outside from the front panel of the device body (refer to JP-A-2003-308642 or US-A-2003/0193872, for example).

FIG. 6 shows the bottom face side of the tray 1, which is provided on its one end side with a rack 4 extending in the longitudinal direction and on its other end side with a generally L-shaped cam groove 5. The tray 1 is provided on the back side with a retaining pawl 6, which is formed near the cam groove 5 for retaining a stopper formed at the open side portion of the body front portion so as to prevent the tray 1 in the open state from coming out of the body front portion. However, the retaining pawl 6 could be broken if the tray 1 is forcibly pulled outward.

The conventional tray 1 slides back and forth, as the pinion rotationally driven by a reversible motor meshes with the rack 4. When the forward movement ends, the switch is turned OFF to stop the forward movement of the tray 1. When the tray 1 in a disk exchanging position, i.e., in the open state is slightly pushed by an operator's hand, the switch is turned ON so that the motor is activated backward rotation, contrary to the forward movement, to start the backward movement. This backward movement of the tray can also be started by operating a button not by the manual push.

At the end of the backward movement, the switch is turned OFF to stop the rotation of the motor. The switch for turning ON/OFF the motor is a three-point switch. This switch is adapted to be activated when its switching arm is pushed by protrusions disposed at a predetermined interval on a rack loader, which moves in the right and left direction as a cam rod boss loosely fitted in the cam groove 5 moves along the cam groove 5. The switch OFF state, in which the tray 1 protrudes to the disk exchanging position, is kept as it is when once turned OFF, due to the straight shape of the rear end of the cam groove 5. In the absence of the retaining pawl 6, the tray 1 can be extracted from the opening of the device.

### SUMMARY OF THE INVENTION

When the tray loaded in the disk recording/reproducing device is pulled from the protruding state to the disk exchanging position, the retaining pawl is caught by the stopper but may be brought out or damaged if it is subjected to an excessive load. This is the problem to be solved by the invention, and the invention has an object to provide a disk recording/reproducing device, which is controlled to block the extraction of a tray by means of a motor for driving the tray forward and backward.

According to the invention, therefore, there is provided a disk recording/reproducing device with a tray, including: a tray for placing a disk thereon to carry in/out the disk; a reversible motor for driving the tray; a pinion connected to the reversible motor rotatably forward and backward; a rack loader made slidable perpendicularly to the carrying direction of the tray; and a switch for turning ON/OFF in response to the sliding action of said rack loader, wherein said rack loader having a cam rod boss rising therefrom, said tray being provided on its bottom face with a rack extending in its carrying direction and meshing with the pinion and with a generally L-shaped cam groove for fitting said cam rod boss loosely therein, said cam groove having a longitudinal cam groove extending in parallel with the rack, a transverse cam groove perpendicular to the rack, a corner cam groove formed obliquely between the longitudinal cam groove and the transverse cam groove, a trapezoidal curve portion formed near the back end of the longitudinal cam groove and curved generally in a trapezoidal shape, and a straight portion formed behind said trapezoidal curve portion and lying on an extension line of the longitudinal cam groove, and a central portion of the trapezoidal curve portion and the corner cam groove portion at passing time of the cam rod boss providing OFF area of the switch whereas the longitudinal cam groove and the straight portion providing ON area of the switch.

On the back of the trapezoidal curve portion of the cam groove, there is further formed a straight portion, which falls on the extension line of the longitudinal cam groove. When the tray in the disk exchanging position is pulled until the cam rod boss comes to the straight portion as ON area of the switch, the motor is restarted to bring back the tray to the initial position of the center of the trapezoidal curve portion.

The switch may include a switch arm arranged near the rack loader and extending toward the rack loader, and the rack loader may be provided with switching ribs at a predetermined interval, so that the switching ribs bring down the switch arm to right and left direction, as the rack loader moves, whereby the switch ON is established when the switch arm is in an upright state whereas the switch OFF is established when the switch arm falls down to the right and left direction.

Thus, according to the disk recording/reproducing device of the invention, the straight portion is further formed on the extension line of the longitudinal cam groove on the back of the trapezoidal curve portion of the cam groove, so that switch ON area is provided at the position where the cam rod boss is at the straight portion. As a result, even if the tray in the disk exchanging position is further pulled forward, when the cam rod boss comes to the straight portion, the motor can be started to move back the tray to the initial disk exchanging position. In other words, the tray is not pulled out of the front panel, and the retaining pawl or the stopper is not damaged by an excessive load.

### BRIEF DESCRIPTION OF THE DRAWING

FIG. 1 is a top plan view showing the state in which a tray in a disk device according to an embodiment of the invention is placed in a disk exchanging position;

FIG. 2 is a bottom plan view showing the tray;

FIGS. 3A, 3B and 3C are bottom plan views showing the states, in which the tray in the disk device is placed in a reproducing position, a moving position and a disk exchanging position, respectively;

FIGS. 4A, 4B and 4C are partially enlarged views showing the relations between the switch and the two switching ribs of the rack loader in FIGS. 3A, 3B and 3C, respectively;

FIGS. 5A and 5B are perspective views showing the appearances of a disk recording/reproducing device equipped with a conventional tray, in the states in which the tray is in a disk exchanging position and a reproducing position, respectively; and

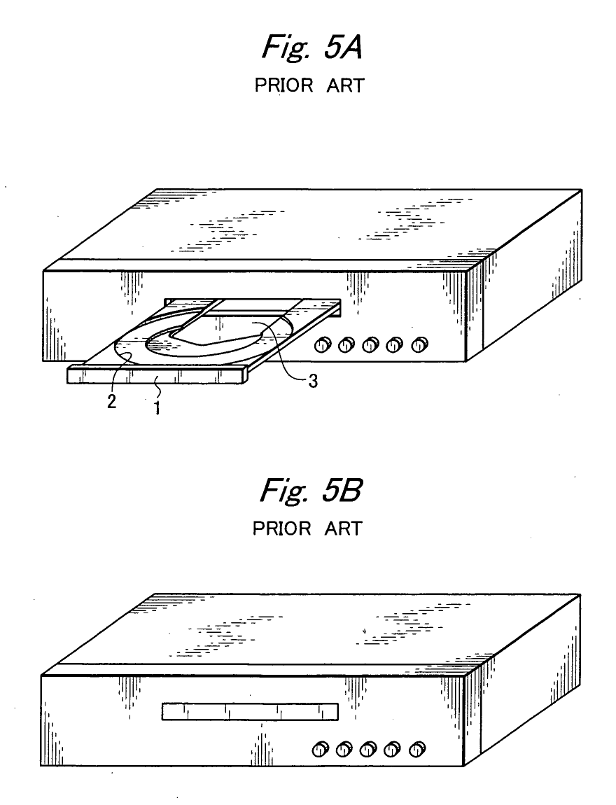

FIG. 6 is a bottom plan view showing the conventional tray.

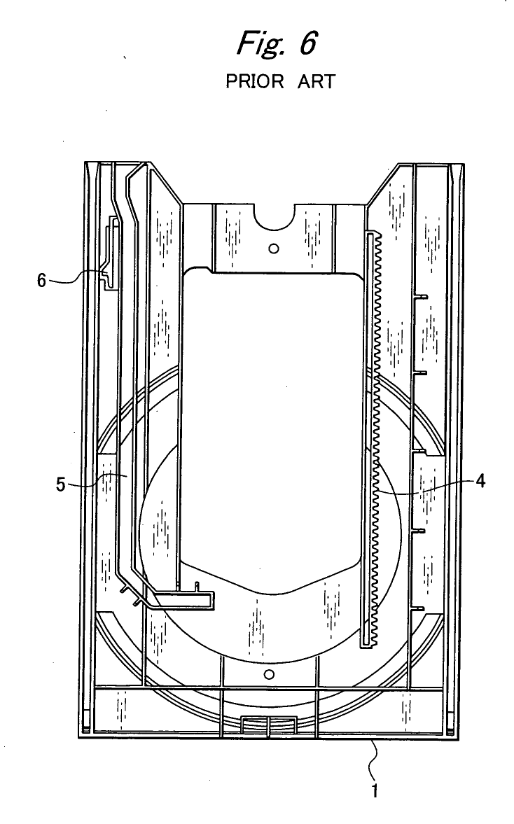

### DETAILED DESCRIPTION OF PREFERRED EMBODIMENT

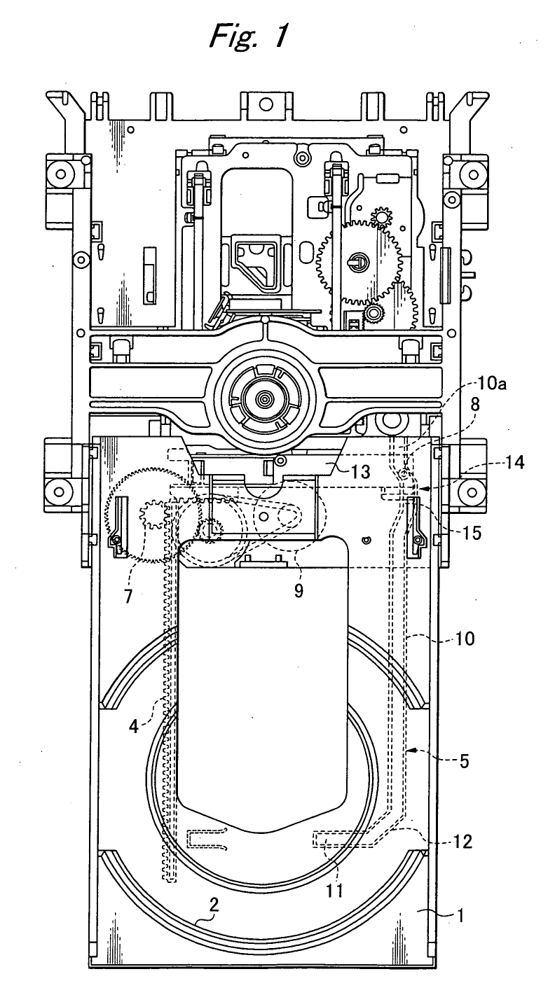

FIG. 1 shows an embodiment of a disk recording/reproducing device according to the invention in an open state, in which a tray 1 is placed in a disk exchanging position. In the upper face of the tray 1, there is formed a shallow step 2 of a circular recess, in which a disk is fitted and set. The tray 1 is provided on one side of its lower face with a rack 4 extending in the longitudinal direction and on the other side with a generally L-shaped cam groove 5. Moreover, a pinion 7 meshes with the rack 4, and a cam rod boss 8 is loosely fitted in the cam groove 5.

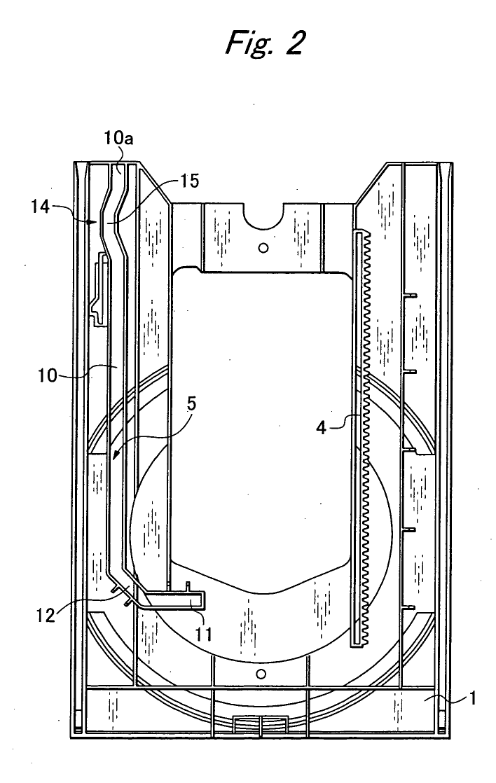

The pinion 7 is rotationally driven by a reversible motor 9. When the pinion 7 is rotated forward and backward, the rack 4 and the tray 1 are moved forward to protrude to the disk exchanging position or are carried into the device to retract to the reproducing position. The tray 1 is moved forward and backward within a predetermined distance between the disk exchanging position and the reproducing position so that the cam rod boss 8 accordingly slides in the cam groove 5 from the front end side to the back end side. As shown in FIG. 2, the rack 4 and the cam groove 5 are formed on the bottom face of the tray 1, and the generally L-shaped cam groove 5 is composed of a longitudinal cam groove 10 parallel to the rack 4, a transverse cam groove 11 perpendicular to the rack 4, and a corner cam groove 12 formed between the longitudinal cam groove 10 and the transverse cam groove 11. Behind the longitudinal cam groove 10, moreover, there is formed a trapezoidal curve portion 14, which is curved generally into a trapezoidal shape.

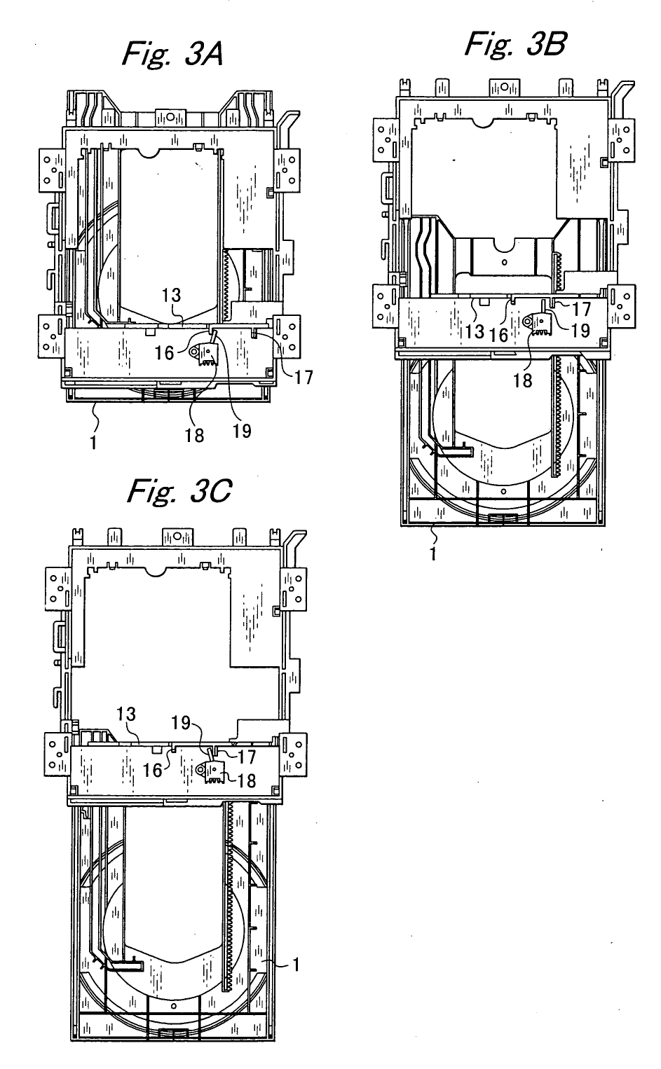

The cam rod boss 8 is protruded from a rack loader 13 disposed on the lower side of the tray 1 to be able to freely move transversely. In accordance with the transverse movement of the cam rod boss 8 in the cam groove 5, therefore, the rack loader 13 moves transversely. To the body chassis, there is attached a switch 18 for driving the reversible motor 9 rotationally. This switch 18 is provided with a switch arm 19 extending toward the rack loader 13. As shown in FIGS. 3A, 3B and 3C, on the other hand, the rack loader 13 is provided at a predetermined interval with switching ribs 16 and 17. When the switching ribs 16 and 17 are brought to abut against the switch arm 19 and bring it down to the right and left direction by the movement of the rack loader 13, the reversible motor 9 is switched ON/OFF.

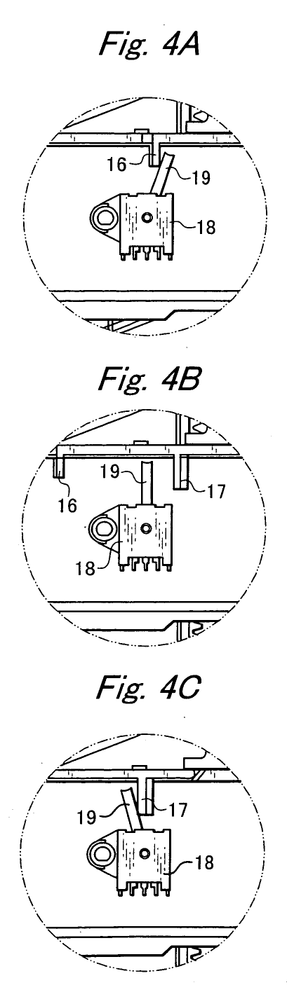

In the trapezoidal curve portion 14 of the cam groove 5, a central portion 15 provides an OFF area of the switch 18, which corresponds to the state of the switch arm 19 of the switch 18 as shown in FIGS. 3C and 4C. The two sides of the central portion 15 provide ON areas across slopes, which correspond to the state of the switch arm 19 as shown in FIGS. 3B and 4B. Moreover, the corner cam groove 12 also provides the OFF area of the switch 18, which corresponds to the state of the switch arm 19 as shown in FIGS. 3A and 4A. In other words, when an eject button disposed in the front panel is pushed, the switch arm 19 of the switch 18 takes the state as shown in FIG. 4B, and the motor 9 is activated to rotate the pinion 7 meshing with the rack 4 so that the tray 1 in the reproducing position is carried out to the front. At this time, the cam rod boss 8 does not move but stands still at a fixed position while being in the straight longitudinal cam groove 10, and the rack loader 13 also stands still.

When the cam rod boss 8 comes from the longitudinal cam groove 10 to the trapezoidal curve portion 14, the rack loader 13 moves leftward in FIG. 3B so that the switching rib 17 pushes down the switch arm 19 of the switch 18 leftward. Then, the motor 9 is turned OFF so that the tray 1 stops (refer to FIG. 3C). When the tray 1 in the disk exchanging position is slightly pushed, the cam rod boss 8 moves from the trapezoidal curve portion 14 to the longitudinal cam groove 10. Then, the switch arm 19 of the switch 18 is raised upright, as shown in FIG. 4B, so that the motor 9 is activated to move the tray 1 backward (refer to FIG. 3B). When the cam rod boss 8 loosely fitted in the longitudinal cam groove 10 comes to the corner cam groove 12, the rack loader 13 moves rightward in FIG. 3B. Then, the switching rib 16 pushes down the switch arm 19 of the switch 18 rightward so that the motor 9 is turned OFF to stop the tray 1 (refer to FIG. 3A). Thus, the cam rod boss 8 moves along the cam groove 5 so that its body i.e. the rack loader 13 moves to the right and left direction to turn ON/OFF the switch 18 and thereby to stop the tray 1.

As shown in FIG. 2, a straight portion 10a is formed above the central portion 15 of the trapezoidal curve portion 14 of the cam groove 5. As described above, the central portion 15 of the trapezoidal curve portion 14 is the OFF area of the switch 18, which corresponds to the state of the switch arm 19 of the switch 18 as shown in FIGS. 3C and 4C. While the cam rod boss 8 exists in the central portion 15 of the trapezoidal curve portion 14, the tray 1 is placed in the disk exchanging position, and the motor 9 is stopped in the OFF state. If the tray 1 in the disk exchanging position is pulled by any operation mistake or error and the cam rod boss 8 comes from the central portion 15 of the trapezoidal curve portion 14 through the slope to the straight portion 10a, the switch arm 19 of the switch 18 is raised to the state as shown in FIG. 4B, so that the motor 9 is activated to drive the pinion 7 and thereby to move the tray 1 back to the initial disk exchanging position. At this time, the control may also be made not to stop the tray 1 at the central portion 15 of the trapezoidal curve portion 14 but to bring the same back to the reproducing position.

1. A disk recording/reproducing device with a tray, comprising: a tray for placing a disk thereon to carry in/out the disk; a reversible motor for driving the tray; a pinion connected to the reversible motor rotatably forward and backward; a rack loader made slidable perpendicularly to the carrying direction of the tray; and a switch for turning ON/OFF in response to the sliding action of said rack loader,
wherein said rack loader having a cam rod boss rising therefrom, said tray being provided on its bottom face with a rack extending in its carrying direction and meshing with the pinion and with a generally L-shaped cam groove for fitting said cam rod boss loosely therein,
said cam groove having a longitudinal cam groove extending in parallel with the rack, a transverse cam groove perpendicular to the rack, a corner cam groove formed obliquely between the longitudinal cam groove and the transverse cam groove, a trapezoidal curve portion formed near the back end of the longitudinal cam groove and curved generally in a trapezoidal shape, and a straight portion formed behind said trapezoidal curve portion and lying on an extension line of the longitudinal cam groove, and
a central portion of the trapezoidal curve portion and the corner cam groove portion at passing time of the cam rod boss providing OFF area of the switch whereas the longitudinal cam groove and the straight portion providing ON area of the switch.

2. A disk recording/reproducing device according to claim 1, wherein said switch is provided with a switch arm arranged near the rack loader and extending toward said rack loader, and the rack loader is provided with switching ribs at a predetermined interval, so that the switching ribs bring down the switch arm to right and left direction, as the rack loader moves, whereby the switch ON is established when the switch arm is in an upright state whereas the switch OFF is established when the switch arm falls down to the right and left direction.
